(19) United States
(12) Patent Application Publication
(10) Pub. No.: US 2019/0164297 A1
(43) Pub. Date: May 30, 2019

(54) CONTROLLING SYSTEM COMPRISING ONE OR MORE CAMERAS

(71) Applicant: TEKNOLOGIAN TUTKIMUSKESKUS VTT OY, Espoo (FI)

(72) Inventors: Paul KEMPPI, Espoo (FI); Otto KORKALO, Espoo (FI)

(73) Assignee: TEKNOLOGIAN TUTKIMUSKESKUS VTT OY, Espoo (FI)

(21) Appl. No.: 16/091,695

(22) PCT Filed: Apr. 6, 2017
(86) PCT No.: PCT/FI2017/050244

§ 371 Date: Oct. 5, 2018

(30) Foreign Application Priority Data
Apr. 7, 2016 (FI) 20165302

(51) Int. Cl. G06T 7/246; G06T 7/292; G06T 7/579; H04N 7/18; H04N 5/33

(52) U.S. Cl. CPC G06T 7/246; G06T 7/292; G06T 2207/10048; H04N 7/181; H04N 5/33; G06T 7/579

(57) ABSTRACT

A method and an apparatus for controlling a system having one or more depth cameras is provided. The solution comprises receiving (402) a control signal from at least one sensor arranged to detect movement in the field of view of at least one depth camera and controlling (404) the operation of the camera system on the basis of the control sensor.

### TECHNICAL FIELD

The exemplary and non-limiting embodiments of the invention relate generally to controlling a system with one or more cameras.

### BACKGROUND

Tracking movements of people or other moving objects such as vehicles is useful in many applications. One known solution for implementing the tracking is to use depth or range cameras. With depth cameras and suitable control system it is possible to monitor a given area and determine the location of moving objects and their movements.

The tracking operation should naturally be as accurate and reliable as possible. The tracking accuracy and reliability suffer from false detections that result from objects being moved around in the scene, for example. The accuracy and reliability may be enhanced by performing background modeling at the installation phase of the system. The signals captured by the depth cameras are analyzed and determined to be background view. If there are moving objects in the scene when depth frames are collected for background modelling, the background and foreground will get mixed.

### BRIEF DESCRIPTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description that is presented later.

According to an aspect of the present invention, there is provided an apparatus for controlling a system having one or more depth cameras, the apparatus comprising: at least one processing circuitry; and at least one memory including computer program code, the at least one memory and the computer program code configured to, with the at least one processing circuitry, cause the apparatus at least to perform: receive a control signal from at least one sensor arranged to detect movement in the field of view of at least one depth camera; control the operation of the camera system on the basis of the control signal.

According to an aspect of the present invention, there is provided a method for controlling a system having one or more depth cameras, comprising: receiving a control signal from at least one sensor arranged to detect movement in the field of view of at least one depth camera; controlling the operation of the camera system on the basis of the control signal.

Some embodiments of the invention are disclosed in the dependent claims.

### BRIEF DESCRIPTION OF THE DRAWINGS

In the following the invention will be described in greater detail by means of preferred embodiments with reference to the accompanying drawings, in which

FIG. 1 illustrates a simplified example of a tracking system;

FIGS. 2 and 3 illustrate simplified examples of apparatuses applying some embodiments of the invention; and

FIGS. 4, 5 and 6 are flowcharts illustrating some embodiments.

### DETAILED DESCRIPTION OF SOME EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may also contain also features, structures, units, modules etc. that have not been specifically mentioned.

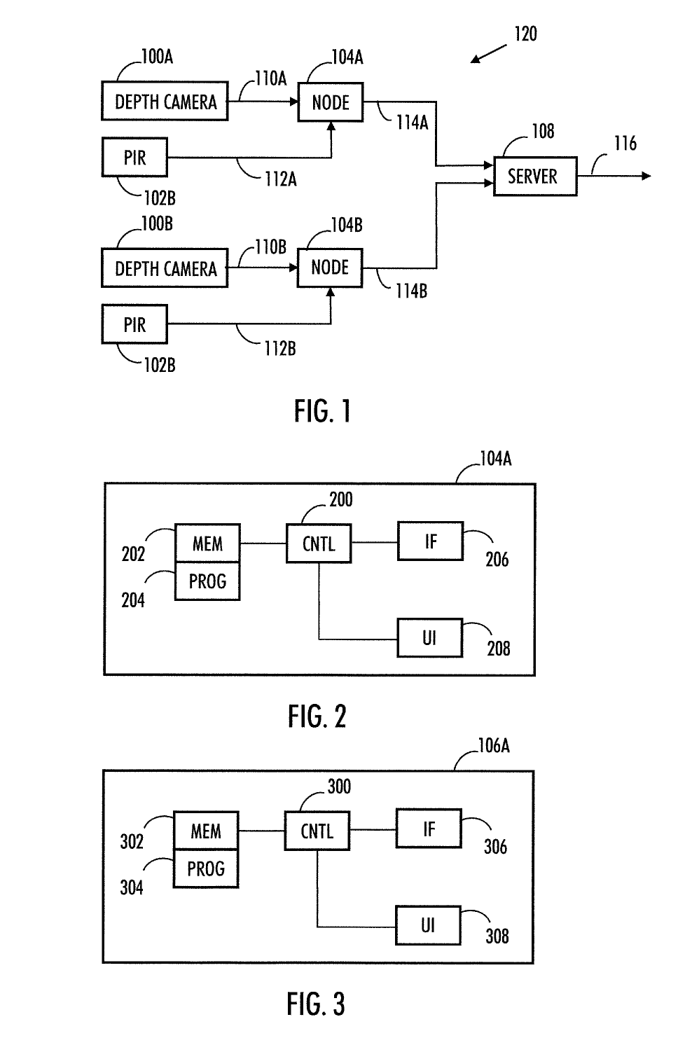

FIG. 1 illustrates a simplified example of a tracking system 120 with having one or more depth or range cameras. A depth or range camera produces an image where each pixel of the image is associated with the distance between the point in the scene depicted by the pixel and the camera. In this example, two depth cameras 100A, 100B are shown. In practise, the number of cameras in a system may be greater. In this example, each camera is connected to a node. Thus, the camera 100A is connected to node 104A and, the camera 100B is connected to node 104B. In some applications it is also possible that multiple cameras are connected to a same node.

The depth cameras may be installed to the area to be monitored in such a manner that the desired part of the area is in the field of view of the cameras.

The nodes process the images sent by the depth cameras. In an embodiment, the nodes are configured to detect movement on the basis of the images captured by the cameras. These detections may be denoted as observations.

The nodes may be connected 114A, 114B to a server 108. The nodes may be configured to send the observations to the server. The server may be configured to process and/or combine information sent by the different nodes and send the results 116 further.

In an embodiment, one of the nodes may act as the server.

The tracking system may further comprise sensors 102A, 102B arranged to detect movement in the field of view of the depth cameras 100A and 100B. In an embodiment, the system may comprise a movement sensor in connection with each camera. Depending on the location and fields of view of the cameras, it may be possible that a single sensor serves more than one camera or multiple sensors are serving one camera.

The sensors may be passive infrared, PIR, sensors, for example. PIR-based motion sensors detect the infrared radiation emitted or reflected from objects in the field of view. They are commonly used in burglar alarms and automatically-activated lighting systems. Their power consumption is minimal compared to the depth cameras which utilise active illumination. The sensors 102A, 102B may be connected 112A, 112B to a node 104A, 104B.

FIGS. 2 and 3 illustrate an embodiment. The figures illustrate simplified example of apparatuses applying embodiments of the invention.

It should be understood that the apparatuses are depicted herein as an examples illustrating some embodiments. It is apparent to a person skilled in the art that the apparatuses may also comprise other functions and/or structures and not all described functions and structures are required. Although the each apparatus has been depicted as one entity, different modules and memory may be implemented in one or more physical or logical entities.

In some embodiments, the apparatus of FIG. 2 may be a node 104A, 104B or a part of a node. The apparatus of the example includes a control circuitry 200 configured to control at least part of the operation of the apparatus.

The apparatus may comprise a memory 202 for storing data. Furthermore the memory may store software 204 executable by the control circuitry 200. The memory may be integrated in the control circuitry.

The apparatus may further comprise an interface circuitry 206 configured to connect the apparatus to other devices, to server 108, to cameras 100A, 100B and to movement sensors 102A, 102B, for example. The interface may provide a wired or wireless connection.

The apparatus may further comprise user interface 208 such as a display, a keyboard and a mouse, for example.

In some embodiments, the apparatus of FIG. 2 may be realised with a personal computer with a suitable interface to depth cameras and other devices.

In some embodiments, the apparatus of FIG. 3 may be a server 108 or a part of a server. The apparatus of the example includes a control circuitry 300 configured to control at least part of the operation of the apparatus.

The apparatus may comprise a memory 302 for storing data. Furthermore the memory may store software 304 executable by the control circuitry 300. The memory may be integrated in the control circuitry.

The apparatus may further comprise an interface circuitry 306 configured to connect the apparatus to other devices and to nodes 104A, 104B. The interface may provide a wired or wireless connection.

The apparatus may further comprise user interface 308 such as a display, a keyboard and a mouse, for example.

In some embodiments, the apparatus of FIG. 3 may be realised with a personal computer or desktop personal computer with a suitable interface to cameras and other devices.

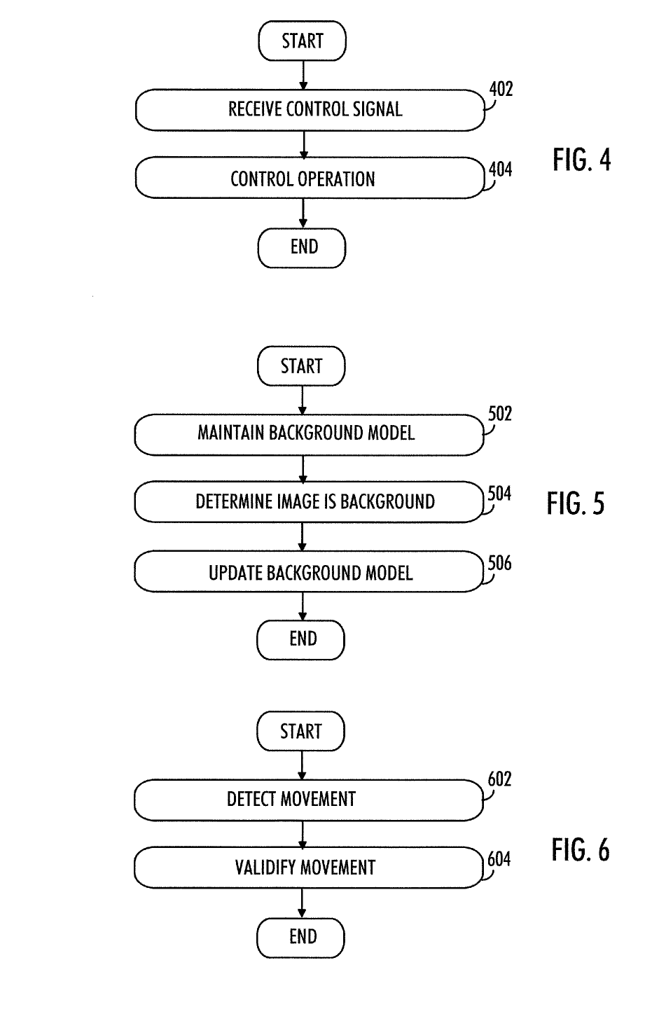

FIG. 4 is a flowchart illustrating an embodiment. The flowchart illustrates the operation of an apparatus of FIG. 2. In an embodiment, the apparatus is the node 104A. The apparatus might as well be node 104B, as one skilled in the art is aware.

In step 402, the apparatus 104A is configured to receive a control signal 112A from at least one sensor 102A which is arranged to detect movement in the field of view of at least one depth camera 100A. In an embodiment, the software 204 may comprise a computer program comprising program code means adapted to cause the control circuitry 200 of the apparatus at least to receive the control signal 112A from the sensor 102A.

In step 404, the apparatus is configured to control the operation of the camera system on the basis of the control sensor. In an embodiment, the software 204 may comprise a computer program comprising program code means adapted to cause the control circuitry 200 of the apparatus at least to control the operation of the camera system on the basis of the control sensor. The control signal indicates whether or not there is movement in the field of view of the camera. The system may take different actions depending on whether movement has been detected or not.

FIG. 5 is a flowchart illustrating a further embodiment. The flowchart illustrates the operation of an apparatus of FIG. 2. In an embodiment, the apparatus is the node 104A. As above, the apparatus might as well be node 102B, as one skilled in the art is aware.

In step 502, the apparatus 104A is configured to maintain a background model related to the images captured by the at least one depth camera 100A. In an embodiment, the software 204 may comprise a computer program comprising program code means adapted to cause the control circuitry 200 of the apparatus at least to maintain a background model related to the images captured by the camera. The background model illustrates the field of view of the camera 100A when there is no movement or no external objects in the field of view. The background model may be utilised when determining whether a detection of movement of external objects has happened in the field of view of the depth camera.

In step 504, the apparatus is configured to determine that the image captured by the at least one depth camera designates background on the basis of the control signal 112A from the movement sensor. In an embodiment, the software 204 may comprise a computer program comprising program code means adapted to cause the control circuitry 200 of the apparatus at least to determine that the image captured by the camera designates background. If the control signal from the sensor indicates that there is no movement or no external objects in the field of view of the camera, it may be determined that the image produced by the depth camera is background.

In step 506, the apparatus is configured to update the background model on the basis of images produced by the depth camera and determined to designate background. In an embodiment, the software 204 may comprise a computer program comprising program code means adapted to cause the control circuitry 200 of the apparatus at least to update the background model on the basis of images produced by the depth camera and determined to designate background.

The images or frames without movement can be used to adjust the background model to adapt faster and more reliably to the changes in the scene in the field of view of the camera. Typically background modelling is usually done at system start up. The person installing the system has to make sure that the scene remains empty during the period when the system collects data for the background modelling. However, the scene may change due to natural oscillations in pixel intensity, variations in lighting, and changes in position of static objects, such as furniture. Thus, after a time the model created at the system start up may not be accurate. By utilising the still periods when there is no movement the model may be kept updated and thus increase the efficiency of the system.

FIG. 6 is a flowchart illustrating another embodiment. The flowchart illustrates the operation of an apparatus of FIG. 2. In an embodiment, the apparatus is the node 104A. As above, the apparatus might as well be node 102B, as one skilled in the art is aware.

In step 602, the apparatus 104A is configured to detect movement on the basis of the images captured by the at least one depth camera 100A. In an embodiment, the software 204 may comprise a computer program comprising program code means adapted to cause the control circuitry 200 of the apparatus at least to detect movement on the basis of the images captured by the camera 100A. The movement may be detected by analysing the images or frames captured by the camera. The analysis may be comparing the images or frames produced by the camera with the background model, for example.

In step 604, the apparatus 104A is configured to determine the validity of the detection on the basis of the control signal 112A from the movement sensor. In an embodiment, the software 204 may comprise a computer program comprising program code means adapted to cause the control circuitry 200 of the apparatus at least to determine the validity of the detection on the basis of the control signal.

If the control signal from the movement sensor indicates that there is movement, the detection made on the basis of the images or frames of the camera is verified. Indication of the movement and possible parameters may be sent to the server. If the control signal from the PIR sensor indicates that there is no movement, the detection may be takes as false. Also false detections may be reported to the server, so that quality inspections may be performed, for example. Thus, the movement sensor usage may also help to detect incorrect tracking results (false negatives during movement and false positives during still time).

In prior art, false negative and positive detections are usually noticed only after manually inspecting the data produced by the cameras and the system. Thus, the efficiency and reliability of the system is considerably increased with the above described process.

In an embodiment, the control step 404 of FIG. 4 may also be realised by pausing the camera operation and camera image analysis performed by the node on the basis of the control signal. When the movement sensor indicates that there is no movement or external objects in the field of view of corresponding camera, the camera may be set in standby state, for example. Also the operation of the node may be set on standby. Thus, the proposed solution reduces power consumption and lowers the thermal stress of the nodes used in the system, because the depth camera data acquisition and processing can also be paused during still periods. In an embodiment, the pause mode may be activated when the background model is up-to-date.

In an embodiment, the camera and node may be woken up from the standby state when the movement sensor detects movement.

In an embodiment, the camera system may be utilised for determining the number of people passing through a given area. Usually this is realised by determining a virtual line in the monitoring area and calculating the number of persons crossing the line. The proposed system may be utilised in the determination of the virtual line. In an embodiment, a person may walk on the line to be defined. When the person stops for a given amount of time, this is detected by the PIR sensors. The point where the person stops may be interpreted as the endpoint or a turning point of the virtual line. In addition, the PIR sensors may be used to detect if extra persons enter the scene during the determination of the virtual line in which case the process may be restarted.

The steps and related functions described in the above and attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described steps may be implemented as an electronic digital computer, which may comprise a working memory (RAM), a central processing unit (CPU), and a system clock. The CPU may comprise a set of registers, an arithmetic logic unit, and a controller. The controller is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An embodiment provides a computer program embodied on a distribution medium, comprising program instructions which, when loaded into an electronic apparatus, are configured to control the apparatus to execute the embodiments described above.

In an embodiment, the invention may be realised with an apparatus comprising means for receiving a control signal from at least one sensor arranged to detect movement in the field of view of at least one depth camera and means for controlling the operation of the camera system on the basis of the control sensor.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst a number of computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

It will be obvious to a person skilled in the art that, as the technology advances, the inventive concept can be implemented in various ways. The invention and its embodiments are not limited to the examples described above but may vary within the scope of the claims.

1. A method for controlling a system having one or more depth cameras, comprising:
receiving a control signal from at least one sensor arranged to detect movement in the field of view of at least one depth camera;
controlling the operation of the camera system on the basis of the control signal.

2. The method according to claim 1, further comprising:
maintaining a background model related to the of the images captured by the at least one depth camera;
determining that the image captured by the at least one depth camera designates background on the basis of the control signal;
and updating the background model on the basis of images determined to designate background.

3. The method according to claim 1, wherein images captured by the cameras are analysed, further comprising:
pausing camera operation and camera image analysis on the basis of the control signal.

4. The method according to claim 1, further comprising:
detecting movement on the basis of the images captured by the at least one depth camera; and
determining the validity of the detection on the basis of the control signal.

5. The method according to claim 1, wherein the sensor is an infrared sensor.

6. The method according to claim 1, wherein the system comprises more than one depth cameras and a sensor configured to detect movement in the field of view of each camera of the system.

7. An apparatus for controlling a system having one or more depth cameras, the apparatus comprising:
at least one processing circuitry; and
at least one memory including computer program code, the at least one memory and the computer program code configured to, with the at least one processing circuitry, cause the apparatus at least to perform:
receive a control signal from at least one sensor arranged to detect movement in the field of view of at least one depth camera;
control the operation of the camera system on the basis of the control signal.

8. The apparatus according to claim 7, the apparatus being further configured to maintain a background model related to the of the images captured by the at least one depth camera;
determine that the image captured by the at least one depth camera designates background on the basis of the control signal;
and update the background model on the basis of images determined to designate background.

9. The apparatus according to claim 7, the apparatus being further configured to:
analyse images captured by the depth cameras; and
pause camera operation and camera image analysis on the basis of the control signal.

10. The apparatus according to claim 7, wherein the sensor is an infrared sensor.
